(19) United States
(12) Patent Application Publication
(10) Pub. No.: US 2023/0044552 A1
(43) Pub. Date: Feb. 9, 2023

(54) Determining Spatial Maps Based on User Input and Motion-Sensing Data Derived from Wireless Signals

(71) Applicant: Cognitive Systems Corp., Waterloo (CA)

(72) Inventor: Mohammad Omer, Waterloo (CA)

(73) Assignee: Cognitive Systems Corp., Waterloo (CA)

(21) Appl. No.: 17/882,091

(22) Filed: Aug. 5, 2022

Related U.S. Application Data
(60) Provisional application No. 63/230,413, filed on Aug. 6, 2021.

(51) Int. Cl. G08B 13/24; G01S 5/10

(52) U.S. Cl. CPC G08B 13/24; G01S 5/10

(57) ABSTRACT

In a general aspect, motion-sensing data are generated based on wireless signals transmitted between respective pairs of wireless communication devices in a wireless communication network. Spatial coordinates are generated for the respective wireless communication devices, and user input is received in response to a graphical representation of a spatial arrangement of the wireless communication devices. The user input indicates a selected group of the wireless communication devices that share a common characteristic. Motion zones in a motion detection system associated with the space are defined. Each of the motion zones represents a distinct region in the space, and the motion zones include a first motion zone representing a region that includes the selected group of the wireless communication devices.

### CROSS-REFERENCE TO RELATED APPLICATIONS

This patent application claims priority to U.S. Provisional Patent Application No. 63/230,413, filed on Aug. 6, 2021. The above-referenced priority document is hereby incorporated by reference.

### BACKGROUND

The following description relates to determining spatial maps based on user input and motion-sensing data derived from wireless signals.

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems.

### DESCRIPTION OF DRAWINGS

FIG. 1 is a diagram showing an example wireless communication system;

FIGS. 2A-2B are diagrams showing example wireless signals communicated between wireless communication devices;

FIG. 2C is a diagram showing an example wireless sensing system operating to detect motion in a space;

FIG. 3 is a diagram showing an example graphical display on a user interface on a user device;

FIG. 4A is a diagram of an example space associated with a wireless communication network;

FIG. 4B a diagram of an example spatial map based on the example space of FIG. 4A;

FIG. 5A is a graph showing example spatial coordinates for respective wireless communication devices in a wireless communication network;

FIG. 5B is graph showing an example spanning tree for the example spatial coordinates of FIG. 5A;

FIG. 6 is a diagram of an example spatial map indicating groups of wireless communication devices selected according to a common characteristic;

FIG. 7 is a flow chart showing an example process 700 performed, for example, by a motion detection system;

FIG. 8A is a block diagram representing an example system that includes a user device and a wireless network interacting with a motion sensing system;

FIG. 8B is a signaling and flow diagram representing example operations that may be performed in the system shown in FIG. 8A; and

FIG. 9 is a block diagram showing an example wireless communication device.

### DETAILED DESCRIPTION

In some aspects of what is described here, a wireless sensing system can process wireless signals (e.g., radio frequency signals) transmitted through a space between wireless communication devices for wireless sensing applications. Example wireless sensing applications include detecting motion, which can include one or more of the following: detecting motion of objects in the space, motion tracking, localization of motion in a space, breathing detection, breathing monitoring, presence detection, gesture detection, gesture recognition, human detection (e.g., moving and stationary human detection), human tracking, fall detection, speed estimation, intrusion detection, walking detection, step counting, respiration rate detection, sleep pattern detection, sleep quality monitoring, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, metal detection, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals.

The examples described herein may be useful for home monitoring. In some instances, home monitoring using the wireless sensing systems described herein may provide several advantages, including full home coverage through walls and in darkness, discreet detection without cameras, higher accuracy and reduced false alerts (e.g., in comparison with sensors that do not use Wi-Fi signals to sense their environments), and adjustable sensitivity. By layering Wi-Fi motion detection capabilities into routers and gateways, a robust motion detection system may be provided.

The examples described herein may also be useful for wellness monitoring. Caregivers want to know their loved ones are safe, while seniors and people with special needs want to maintain their independence at home with dignity. In some instances, wellness monitoring using the wireless sensing systems described herein may provide a solution that uses wireless signals to detect motion without using cameras or infringing on privacy, generates alerts when unusual activity is detected, tracks sleep patterns, and generates preventative health data. For example, caregivers can monitor motion, visits from health care professionals, and unusual behavior such as staying in bed longer than normal. Furthermore, motion is monitored unobtrusively without the need for wearable devices, and the wireless sensing systems described herein offer a more affordable and convenient alternative to assisted living facilities and other security and health monitoring tools.

The examples described herein may also be useful for setting up a smart home. In some examples, the wireless sensing systems described herein use predictive analytics and artificial intelligence (AI), to learn motion patterns and trigger smart home functions accordingly. Examples of smart home functions that may be triggered include adjusting the thermostat when a person walks through the front door, turning other smart devices on or off based on preferences, automatically adjusting lighting, adjusting HVAC systems based on present occupants, etc.

In some aspects of what is described here, a motion detection system includes a plurality of wireless communication devices placed throughout a physical space, such as a residence, a workplace, and so forth. The plurality of wireless communication devices is part of a wireless communication network and may include client devices, such as mobile devices, smartphones, smart watches, tablets, laptop computers, smart thermostats, wireless-enabled cameras, smart TVs, wireless-enabled speakers, wireless-enabled power sockets, and so forth. The plurality of wireless communication devices may also include wireless access points (APs) capable of connecting the client devices to the wireless communication network. In some variations, the plurality of wireless access points defines a wireless mesh network.

During operation, the plurality of wireless communication devices may be associated with respective media access control (MAC) that are unique to each wireless communication device (or wireless communication interface therein). However, the MAC addresses—which are typically represented by pairs of alphanumeric characters—do not indicate a positional information such as a location of a wireless communications device in the space or a distance of the wireless communication device relative to another wireless communication device. As such, a user of the motion detection system is unable to perceive the space in which the one or more wireless communication devices reside based on the MAC addresses.

However, the motion detection system may be configured to generate motion-sensing data based on wireless signals exchanged between the plurality of wireless communication devices. The wireless signals may be transmitted across wireless links defined by respective pairs of wireless communication devices in the wireless communication network. Moreover, the wireless links may extend through respective portions of the space. As such, the motion of an object or person in the space may disturb one or more wireless signals and thus allow the motion detection system to generate the motion-sensing data. The motion detection system uses the motion-sensing data to localize the motion of the object or person in the space. In many instances, the motion detection system informs the user where motion is happening in the space by identifying one or more wireless communication devices closest to the motion. Such identification may be made based on a spatial map of the wireless communication devices in the space. The spatial map may assist the user in perceiving the space and motion therein.

The motion detection system may generate the spatial map during an initial period of operation (e.g., a few hours). In doing so, the motion detection system may collect motion-sensing data and then use the collected motion-sensing data to determine the locations of the plurality of communication devices relative to each other. The locations may correspond to physical or logical distances between respective pairs of wireless communication devices. The physical or logical distances may be based on, respectively, a physical or logical coordinate system for the spatial map.

The motion detection system is also configured to present the spatial map to the user (e.g., via a display device) to allow the user to input information that defines additional features of the space. For example, the user may input information associating groups of wireless communication devices that share a common characteristic (e.g., devices that are in the same room). After receiving this input, the motion detection system may generate configuration data (e.g., motion zones) that represents these additional features. The configuration data may be subsequently used by the motion detection system to display information on a graphical interface that represents the spatial map with its additional features. The configuration data may also be used by the motion detection system to conduct an operation (e.g., send a notification to the user) based on the additional features.

In some implementations, the motion detection system is configured to receive instructions from the user to assign one or more wireless communication devices on the spatial map to a motion zone in the space. The motion zone may be based on a region shared in common by the one or more wireless communication devices. For example, the space may be a house that includes a living room having multiple wireless communication devices therein. If motion occurs in the living room, the user may prefer to know that the motion occurred in the living room instead of at a specific wireless communication device in the living room. In this case, the user may instruct the motion detection system to create a motion zone entitled “living room” and assign the multiple wireless communication devices to this motion zone. The motion zone and its associated room may correspond to additional features provided by the user for the spatial map. If desired, the user may repeat this process for other rooms in the house and thus add further features to the spatial map. The motion detection system may then generate configuration data based on the information that will later assist the user perceiving motion detected in the house.

In some instances, aspects of the systems and techniques described here provide technical improvements and advantages over existing approaches. For example, the systems and techniques allow a user to tailor a spatial map representing a plurality of wireless communication devices to a space containing the plurality of wireless communication devices. The resulting spatial map provides a more intuitive representation of the space to the user, especially when identifying what regions of the space experience motion. As another example, the systems and techniques relieve the user from having to manually construct the spatial map. Instead, the motion detection system constructs the spatial map on behalf of the user based on the motion-sensing data. The motion-sensing data then allows the user to refine the spatial map to their specific preferences. The technical improvements and advantages achieved in examples where the wireless sensing system is used for motion detection may also be achieved in other examples where the wireless sensing system is used for other wireless sensing applications.

In some instances, a wireless sensing system can be implemented using a wireless communication network. Wireless signals received at one or more wireless communication devices in the wireless communication network may be analyzed to determine channel information for the different communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at particular angles experience constructive interference while others experience destructive interference.

The channel information for each of the communication links may be analyzed by one or more motion detection algorithms (e.g., running on a hub device, a client device, or other device in the wireless communication network, or on a remote device communicably coupled to the network) to detect, for example, whether motion has occurred in the space, to determine a relative location of the detected motion, or both. In some aspects, the channel information for each of the communication links may be analyzed to detect whether an object is present or absent, e.g., when no motion is detected in the space.

In some instances, a motion detection system returns motion-sensing data. In some implementations, motion-sensing data is a result that is indicative of a degree of motion in the space, the location of motion in the space, a time at which the motion occurred, or a combination thereof. In some instances, motion-sensing data may include data representing a position of the one or more wireless communication devices relative to each other. For example, the data-sensing may represent a distance between pairs of wireless communication devices in the wireless communication network. The distance may be based on a physical or logical coordinate system. In the latter case, the logical coordinate system may be used to indicate distances other than physical distances. In some instances, the motion-sensing data can include a motion score, which may include, or may be, one or more of the following: a scalar quantity indicative of a level of signal perturbation in the environment accessed by the wireless signals; an indication of whether there is motion; an indication of whether there is an object present; or an indication or classification of a gesture performed in the environment accessed by the wireless signals.

In some implementations, the motion detection system can be implemented using one or more motion detection algorithms. Example motion detection algorithms that can be used to generate motion-sensing data and detect motion based on wireless signals include the techniques described in U.S. Pat. No. 9,523,760 entitled “Detecting Motion Based on Repeated Wireless Transmissions,” U.S. Pat. No. 9,584,974 entitled “Detecting Motion Based on Reference Signal Transmissions,” U.S. Pat. No. 10,051,414 entitled “Detecting Motion Based On Decompositions Of Channel Response Variations,” U.S. Pat. No. 10,048,350 entitled “Motion Detection Based on Groupings of Statistical Parameters of Wireless Signals,” U.S. Pat. No. 10,108,903 entitled “Motion Detection Based on Machine Learning of Wireless Signal Properties,” U.S. Pat. No. 10,109,167 entitled “Motion Localization in a Wireless Mesh Network Based on Motion Indicator Values,” U.S. Pat. No. 10,109,168 entitled “Motion Localization Based on Channel Response Characteristics,” U.S. Pat. No. 10,743,143 entitled “Determining a Motion Zone for a Location of Motion Detected by Wireless Signals,” U.S. Pat. No. 10,605,908 entitled “Motion Detection Based on Beamforming Dynamic Information from Wireless Standard Client Devices,” U.S. Pat. No. 10,605,907 entitled “Motion Detection by a Central Controller Using Beamforming Dynamic Information,” U.S. Pat. No. 10,600,314 entitled “Modifying Sensitivity Settings in a Motion Detection System,” U.S. Pat. No. 10,567,914 entitled “Initializing Probability Vectors for Determining a Location of Motion Detected from Wireless Signals,” U.S. Pat. No. 10,565,860 entitled “Offline Tuning System for Detecting New Motion Zones in a Motion Detection System,” U.S. Pat. No. 10,506,384 entitled “Determining a Location of Motion Detected from Wireless Signals Based on Prior Probability,” U.S. Pat. No. 10,499,364 entitled “Identifying Static Leaf Nodes in a Motion Detection System,” U.S. Pat. No. 10,498,467 entitled “Classifying Static Leaf Nodes in a Motion Detection System,” U.S. Pat. No. 10,460,581 entitled “Determining a Confidence for a Motion Zone Identified as a Location of Motion for Motion Detected by Wireless Signals,” U.S. Pat. No. 10,459,076 entitled “Motion Detection based on Beamforming Dynamic Information,” U.S. Pat. No. 10,459,074 entitled “Determining a Location of Motion Detected from Wireless Signals Based on Wireless Link Counting,” U.S. Pat. No. 10,438,468 entitled “Motion Localization in a Wireless Mesh Network Based on Motion Indicator Values,” U.S. Pat. No. 10,404,387 entitled “Determining Motion Zones in a Space Traversed by Wireless Signals,” U.S. Pat. No. 10,393,866 entitled “Detecting Presence Based on Wireless Signal Analysis,” U.S. Pat. No. 10,380,856 entitled “Motion Localization Based on Channel Response Characteristics,” U.S. Pat. No. 10,318,890 entitled “Training Data for a Motion Detection System using Data from a Sensor Device,” U.S. Pat. No. 10,264,405 entitled “Motion Detection in Mesh Networks,” U.S. Pat. No. 10,228,439 entitled “Motion Detection Based on Filtered Statistical Parameters of Wireless Signals,” U.S. Pat. No. 10,129,853 entitled “Operating a Motion Detection Channel in a Wireless Communication Network,” U.S. Pat. No. 10,111,228 entitled “Selecting Wireless Communication Channels Based on Signal Quality Metrics,” and other techniques.

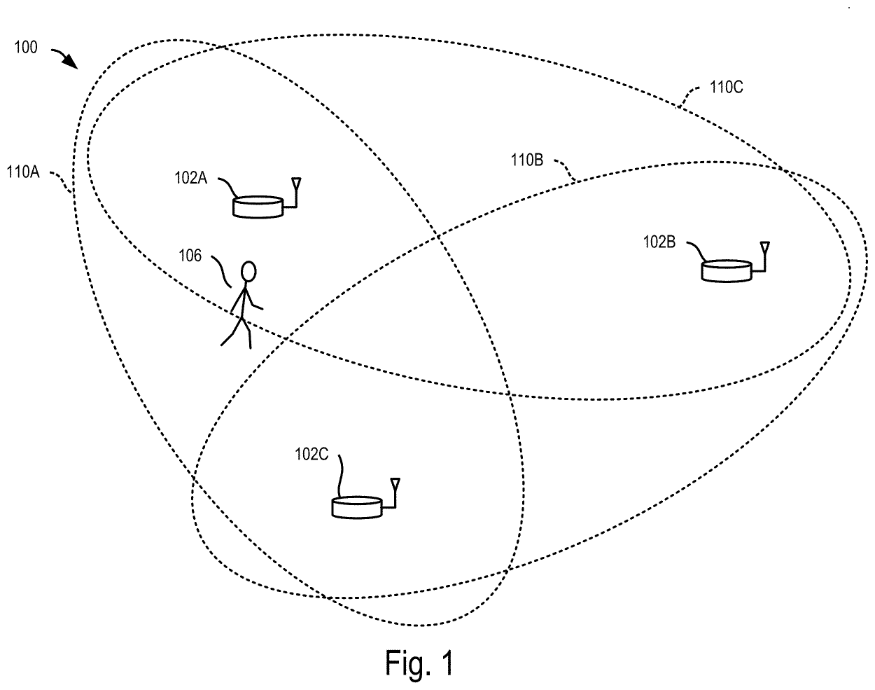

FIG. 1 illustrates an example wireless communication system 100. The wireless communication system 100 may perform one or more operations of a motion detection system. The technical improvements and advantages achieved from using the wireless communication system 100 to detect motion are also applicable in examples where the wireless communication system 100 is used for another wireless sensing application.

The example wireless communication system 100 includes three wireless communication devices 102A, 102B, 102C. The example wireless communication system 100 may include additional wireless communication devices 102 and/or other components (e.g., one or more network servers, network routers, network switches, cables, or other communication links, etc.).

The example wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others.

In some implementations, the wireless communication devices 102A, 102B, 102C may be configured to communicate in a cellular network, for example, according to a cellular network standard. Examples of cellular networks include: networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In some cases, one or more of the wireless communication devices 102 is a Wi-Fi access point or another type of wireless access point (WAP). In some cases, one or more of the wireless communication devices 102 is an access point of a wireless mesh network, such as, for example, a commercially-available mesh network system (e.g., GOOGLE Wi-Fi, EERO mesh, etc.). In some instances, one or more of the wireless communication devices 102 can be implemented as wireless access points (APs) in a mesh network, while the other wireless communication device(s) 102 are implemented as leaf devices (e.g., mobile devices, smart devices, etc.) that access the mesh network through one of the APs. In some cases, one or more of the wireless communication devices 102 is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

In the example shown in FIG. 1, the wireless communication devices transmit wireless signals to each other over wireless communication links (e.g., according to a wireless network standard or a non-standard wireless communication protocol), and the wireless signals communicated between the devices can be used as motion probes to detect motion of objects in the signal paths between the devices. In some implementations, standard signals (e.g., channel sounding signals, beacon signals), non-standard reference signals, or other types of wireless signals can be used as motion probes.

In the example shown in FIG. 1, the wireless communication link between the wireless communication devices 102A, 102C can be used to probe a first motion detection zone 110A, the wireless communication link between the wireless communication devices 102B, 102C can be used to probe a second motion detection zone 110B, and the wireless communication link between the wireless communication device 102A, 102B can be used to probe a third motion detection zone 110C. In some instances, the motion detection zones 110 can include, for example, air, solid materials, liquids, or another medium through which wireless electromagnetic signals may propagate.

In the example shown in FIG. 1, when an object moves in any of the motion detection zones 110, the motion detection system may detect the motion based on signals transmitted through the relevant motion detection zone 110. Generally, the object can be any type of static or moveable object, and can be living or inanimate. For example, the object can be a human (e.g., the person 106 shown in FIG. 1), an animal, an inorganic object, or another device, apparatus, or assembly, an object that defines all or part of the boundary of a space (e.g., a wall, door, window, etc.), or another type of object.

In some examples, the wireless signals propagate through a structure (e.g., a wall) before or after interacting with a moving object, which may allow the object's motion to be detected without an optical line-of-sight between the moving object and the transmission or receiving hardware. In some instances, the motion detection system may communicate the motion detection event to another device or system, such as a security system or a control center.

In some cases, the wireless communication devices 102 themselves are configured to perform one or more operations of the motion detection system, for example, by executing computer-readable instructions (e.g., software or firmware) on the wireless communication devices. For example, each device may process received wireless signals to detect motion based on changes in the communication channel. In some cases, another device (e.g., a remote server, a cloud-based computer system, a network-attached device, etc.) is configured to perform one or more operations of the motion detection system. For example, each wireless communication device 102 may send channel information to a specified device, system, or service that performs operations of the motion detection system.

In an example aspect of operation, wireless communication devices 102A, 102B may broadcast wireless signals or address wireless signals to the other wireless communication device 102C, and the wireless communication device 102C (and potentially other devices) receives the wireless signals transmitted by the wireless communication devices 102A, 102B. The wireless communication device 102C (or another system or device) then processes the received wireless signals to detect motion of an object in a space accessed by the wireless signals (e.g., in the zones 110A, 11B). In some instances, the wireless communication device 102C (or another system or device) may perform one or more operations of a motion detection system.

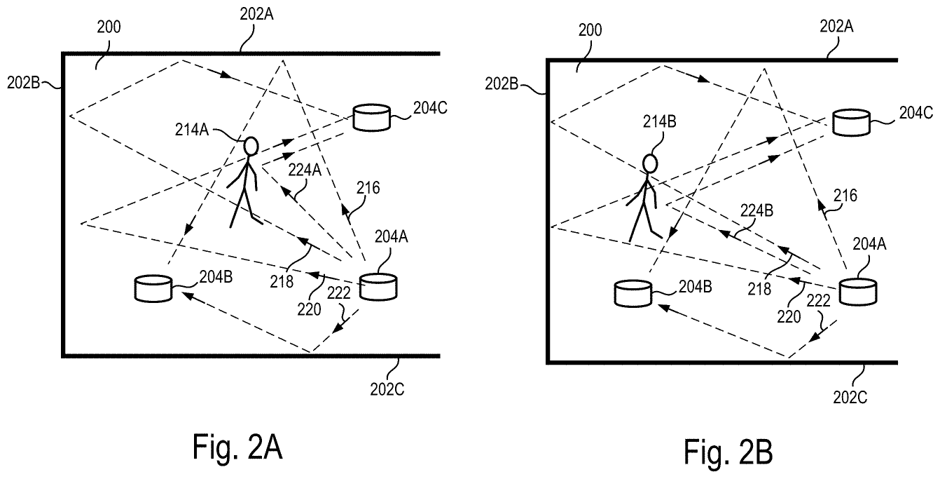

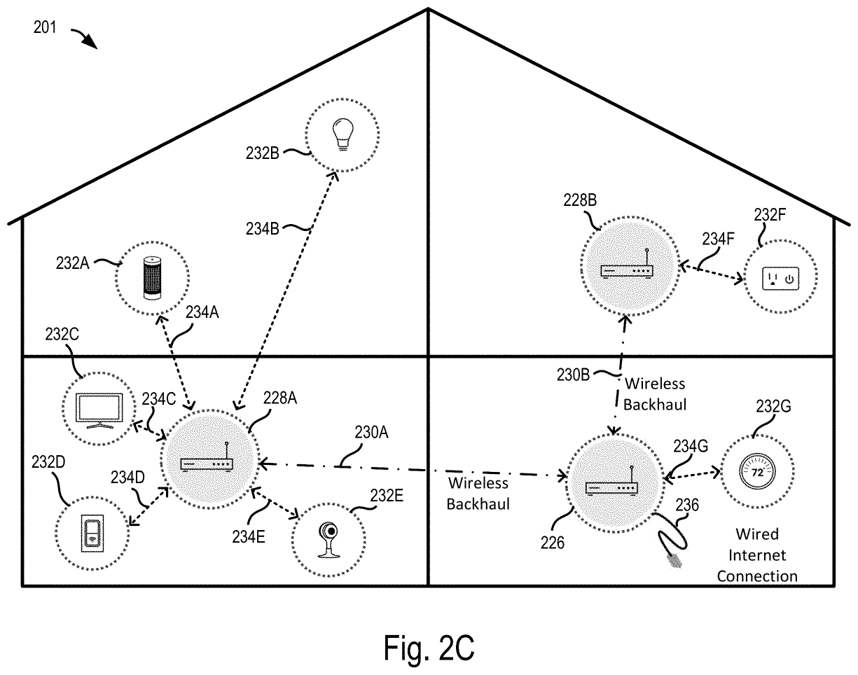

FIGS. 2A and 2B are diagrams showing example wireless signals communicated between wireless communication devices 204A, 204B, 204C. The wireless communication devices 204A, 204B, 204C can be, for example, the wireless communication devices 102A, 102B, 102C shown in FIG. 1, or may be other types of wireless communication devices.

In some cases, a combination of one or more of the wireless communication devices 204A, 204B, 204C can be part of, or may be used by, a motion detection system. The example wireless communication devices 204A, 204B, 204C can transmit wireless signals through a space 200. The example space 200 may be completely or partially enclosed or open at one or more boundaries of the space 200. The space 200 may be or may include an interior of a room, multiple rooms, a building, an indoor area, outdoor area, or the like. A first wall 202A, a second wall 202B, and a third wall 202C at least partially enclose the space 200 in the example shown.

In the example shown in FIGS. 2A and 2B, the first wireless communication device 204A transmits wireless motion probe signals repeatedly (e.g., periodically, intermittently, at scheduled, unscheduled, or random intervals, etc.). The second and third wireless communication devices 204B, 204C receive signals based on the motion probe signals transmitted by the wireless communication device 204A.

As shown, an object is in a first position 214A at an initial time (to) in FIG. 2A, and the object has moved to a second position 214B at subsequent time (ti) in FIG. 2B. In FIGS. 2A and 2B, the moving object in the space 200 is represented as a human, but the moving object can be another type of object. For example, the moving object can be an animal, an inorganic object (e.g., a system, device, apparatus, or assembly), an object that defines all or part of the boundary of the space 200 (e.g., a wall, door, window, etc.), or another type of object. In the example shown in FIGS. 2A and 2B, the wireless communication devices 204A, 204B, 204C are stationary and are, consequently, at the same position at the initial time to and at the subsequent time ti. However, in other examples, one or more of the wireless communication devices 204A, 204B, 204C are mobile and may move between initial time to and subsequent time ti.

As shown in FIGS. 2A and 2B, multiple example paths of the wireless signals transmitted from the first wireless communication device 204A are illustrated by dashed lines. Along a first signal path 216, the wireless signal is transmitted from the first wireless communication device 204A and reflected off the first wall 202A toward the second wireless communication device 204B. Along a second signal path 218, the wireless signal is transmitted from the first wireless communication device 204A and reflected off the second wall 202B and the first wall 202A toward the third wireless communication device 204C. Along a third signal path 220, the wireless signal is transmitted from the first wireless communication device 204A and reflected off the second wall 202B toward the third wireless communication device 204C. Along a fourth signal path 222, the wireless signal is transmitted from the first wireless communication device 204A and reflected off the third wall 202C toward the second wireless communication device 204B.

In FIG. 2A, along a fifth signal path 224A, the wireless signal is transmitted from the first wireless communication device 204A and reflected off the object at the first position 214A toward the third wireless communication device 204C. Between time to in FIG. 2A and time ti in FIG. 2B, the object moves from the first position 214A to a second position 214B in the space 200 (e.g., some distance away from the first position 214A). In FIG. 2B, along a sixth signal path 224B, the wireless signal is transmitted from the first wireless communication device 204A and reflected off the object at the second position 214B toward the third wireless communication device 204C. The sixth signal path 224B depicted in FIG. 2B is longer than the fifth signal path 224A depicted in FIG. 2A due to the movement of the object from the first position 214A to the second position 214B. In some examples, a signal path can be added, removed, or otherwise modified due to movement of an object in a space.

The example wireless signals shown in FIGS. 2A and 2B can experience attenuation, frequency shifts, phase shifts, or other effects through their respective paths and may have portions that propagate in another direction, for example, through the walls 202A, 202B, and 202C. In some examples, the wireless signals are radio frequency (RF) signals. The wireless signals may include other types of signals.

The transmitted signal can have a number of frequency components in a frequency bandwidth, and the transmitted signal may include one or more bands within the frequency bandwidth. The transmitted signal may be transmitted from the first wireless communication device 204A in an omnidirectional manner, in a directional manner, or otherwise. In the example shown, the wireless signals traverse multiple respective paths in the space 200, and the signal along each path can become attenuated due to path losses, scattering, reflection, or the like and may have a phase or frequency offset.

As shown in FIGS. 2A and 2B, the signals from various paths 216, 218, 220, 222, 224A, and 224B combine at the third wireless communication device 204C and the second wireless communication device 204B to form received signals. Because of the effects of the multiple paths in the space 200 on the transmitted signal, the space 200 may be represented as a transfer function (e.g., a filter) in which the transmitted signal is input and the received signal is output. When an object moves in the space 200, the attenuation or phase offset applied to a wireless signal along a signal path can change, and hence, the transfer function of the space 200 can change. When the same wireless signal is transmitted from the first wireless communication device 204A, if the transfer function of the space 200 changes, the output of that transfer function, e.g., the received signal, can also change. A change in the received signal can be used to detect motion of an object. Conversely, in some cases, if the transfer function of the space does not change, the output of the transfer function—the received signal—may not change.

FIG. 2C is a diagram showing an example wireless sensing system operating to detect motion in a space 201. The example space 201 shown in FIG. 2C is a home that includes multiple distinct spatial regions or zones. In the example shown, the wireless motion detection system uses a multi-AP home network topology (e.g., mesh network or a Self-Organizing-Network (SON)), which includes three access points (APs): a central access point 226 and two extension access points 228A, 228B. In a typical multi-AP home network, each AP typically supports multiple bands (2.4G, 5G, 6G), and multiple bands may be enabled at the same time. Each AP can use a different Wi-Fi channel to serve its clients, as this may allow for better spectrum efficiency.

In the example shown in FIG. 2C, the wireless communication network includes a central access point 226. In a multi-AP home Wi-Fi network, one AP may be denoted as the central AP. This selection, which is often managed by manufacturer software running on each AP, is typically the AP that has a wired Internet connection 236. The other APs 228A, 228B connect to the central AP 226 wirelessly, through respective wireless backhaul connections 230A, 230B. The central AP 226 may select a wireless channel different from the extension APs to serve its connected clients.

In the example shown in FIG. 2C, the extension APs 228A, 228B extend the range of the central AP 226, by allowing devices to connect to a potentially closer AP or different channel. The end user need not be aware of which AP the device has connected to, as all services and connectivity would generally be identical. In addition to serving all connected clients, the extension APs 228A, 228B connect to the central AP 226 using the wireless backhaul connections 230A, 230B to move network traffic between other APs and provide a gateway to the Internet. Each extension AP 228A, 228B may select a different channel to serve its connected clients.

In the example shown in FIG. 2C, client devices (e.g., Wi-Fi client devices) 232A, 232B, 232C, 232D, 232E, 232F, 232G are associated with either the central AP 226 or one of the extension APs 228 using a respective wireless link 234A, 234B, 234C, 234D, 234E, 234F, 234G. The client devices 232 that connect to the multi-AP network may operate as leaf nodes in the multi-AP network. In some implementations, the client devices 232 may include wireless-enabled devices (e.g., mobile devices, a smartphone, a smart watch, a tablet, a laptop computer, a smart thermostat, a wireless-enabled camera, a smart TV, a wireless-enabled speaker, a wireless-enabled power socket, etc.).

When the client devices 232 seek to connect to and associate with their respective APs 226, 228, the client devices 232 may go through an authentication and association phase with their respective APs 226, 228. Among other things, the association phase assigns address information (e.g., an association ID or another type of unique identifier) to each of the client devices 232. For example, within the IEEE 802.11 family of standards for Wi-Fi, each of the client devices 232 can identify itself using a unique address (e.g., a 48-bit address, an example being the MAC address), although the client devices 232 may be identified using other types of identifiers embedded within one or more fields of a message. The address information (e.g., MAC address or another type of unique identifier) can be either hardcoded and fixed, or randomly generated according to the network address rules at the start of the association process. Once the client devices 232 have associated to their respective APs 226, 228, their respective address information may remain fixed. Subsequently, a transmission by the APs 226, 228 or the client devices 232 typically includes the address information (e.g., MAC address) of the transmitting wireless device and the address information (e.g., MAC address) of the receiving device.

In the example shown in FIG. 2C, the wireless backhaul connections 230A, 230B carry data between the APs and may also be used for motion detection. Each of the wireless backhaul channels (or frequency bands) may be different than the channels (or frequency bands) used for serving the connected Wi-Fi devices.

In the example shown in FIG. 2C, wireless links 234A, 234B, 234C, 234D, 234E, 234F, 234G may include a frequency channel used by the client devices 232A, 232B, 232C, 232D, 232E, 232F, 232G to communicate with their respective APs 226, 228. Each AP can select its own channel independently to serve their respective client devices, and the wireless links 234 may be used for data communications as well as motion detection.

The motion detection system, which may include one or more motion detection or localization processes running on one or more of the client devices 232 or on one or more of the APs 226, 228, may collect and process data (e.g., channel information) corresponding to local links that are participating in the operation of the wireless sensing system. The motion detection system can be installed as a software or firmware application on the client devices 232 or on the APs 226, 228, or may be part of the operating systems of the client devices 232 or the APs 226, 228.

In some implementations, the APs 226, 228 do not contain motion detection software and are not otherwise configured to perform motion detection in the space 201. Instead, in such implementations, the operations of the motion detection system are executed on one or more of the client devices 232. In some implementations, the channel information may be obtained by the client devices 232 by receiving wireless signals from the APs 226, 228 (or possibly from other client devices 232) and processing the wireless signal to obtain the channel information. For example, the motion detection system running on the client devices 232 can have access to channel information provided by the client device's radio firmware (e.g., Wi-Fi radio firmware) so that channel information may be collected and processed.

In some implementations, the client devices 232 send a request to their corresponding AP 226, 228 to transmit wireless signals that can be used by the client device as motion probes to detect motion of objects in the space 201. The request sent to the corresponding AP 226, 228 may be a null data packet frame, a beamforming request, a ping, standard data traffic, or a combination thereof. In some implementations, the client devices 232 are stationary while performing motion detection in the space 201. In other examples, one or more of the client devices 232 can be mobile and may move within the space 201 while performing motion detection.

Mathematically, a signal f(t) transmitted from a wireless communication device (e.g., the wireless communication device 204A in FIGS. 2A and 2B or the APs 226, 228 in FIG. 2C) may be described according to Equation (1):

$$f ( t ) = {\sum }_{n = - ∞}^{∞} {c}_{n} {e}^{j {ω}_{n} t} \qquad ( 1 )$$

where ωₙ represents the frequency of n^{th} frequency component of the transmitted signal, cₙ represents the complex coefficient of the n^{th} frequency component, and t represents time. With the transmitted signal f(t) being transmitted, an output signal rₖ(t) from a path k may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

where α_{n,k} represents an attenuation factor (or channel response; e.g., due to scattering, reflection, and path losses) for the n^{th} frequency component along path k, and ϕ_{n,k} represents the phase of the signal for n^{th} frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device (e.g., the wireless communication devices 204B, 204C in FIGS. 2A and 2B or the client devices 232 or the APs 226, 228 in FIG. 2C) can then be analyzed (e.g., using one or more motion detection algorithms) to detect motion. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Yₙ may be represented as follows in Equation (5):

$${Y}_{n} = {\sum }_{k} {c}_{n} {α}_{n , k} {e}^{j {ϕ}_{n , k}} . \qquad ( 5 )$$

The complex value Yₙ for a given frequency component ωₙ indicates a relative magnitude and phase offset of the received signal at that frequency component ωₙ. The signal f(t) may be repeatedly transmitted within a time period, and the complex value Yₙ can be obtained for each transmitted signal f(t). When an object moves in the space, the complex value Yₙ changes over the time period due to the channel response α_{n,k} of the space changing. Accordingly, a change detected in the channel response (and thus, the complex value Yₙ) can be indicative of motion of an object within the communication channel. Conversely, a stable channel response may indicate lack of motion. Thus, in some implementations, the complex values Yₙ for each of multiple devices in a wireless network can be processed to detect whether motion has occurred in a space traversed by the transmitted signals f(t). The channel response can be expressed in either the time-domain or frequency-domain, and the Fourier-Transform or Inverse-Fourier-Transform can be used to switch between the time-domain expression of the channel response and the frequency-domain expression of the channel response.

In another aspect of FIGS. 2A, 2B, 2C, beamforming state information may be used to detect whether motion has occurred in a space traversed by the transmitted signals f(t). For example, beamforming may be performed between devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. In some instances, changes to the steering or feedback properties used in the beamforming process indicate changes, which may be caused by moving objects in the space accessed by the wireless signals. For example, motion may be detected by identifying substantial changes in the communication channel, e.g., as indicated by a channel response, steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these beamforming matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, “modes” of a beamforming matrix (e.g., a feedback matrix or steering matrix) can be used to generate the spatial map. The spatial map may be used to detect the presence of motion in the space or to detect a location of the detected motion.

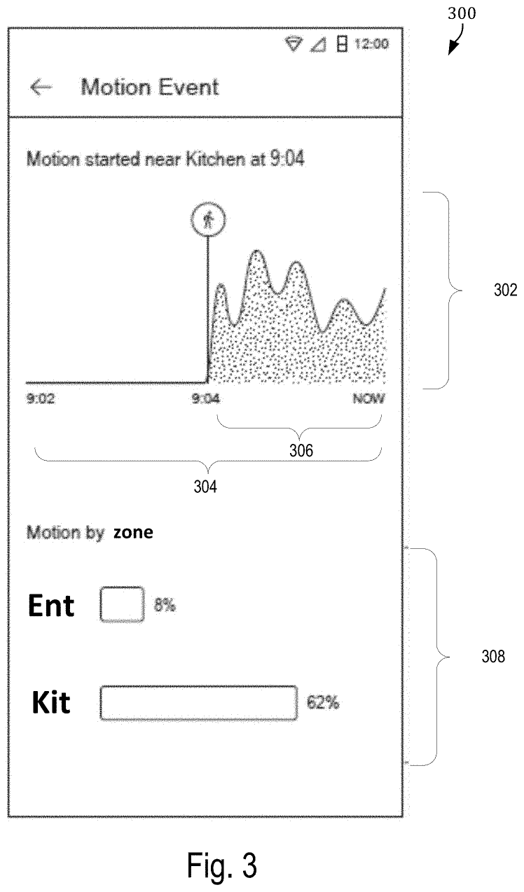

In some implementations, the output of the motion detection system may be provided as a notification for graphical display on a user interface on a user device. FIG. 3 is a diagram showing an example graphical display on a user interface 300 on a user device. In some implementations, the user device is the client device 232 used to detect motion, a user device of a caregiver or emergency contact designated to an individual in the space 200, 201, or any other user device that is communicatively coupled to the motion detection system to receive notifications from the motion detection system.

The example user interface 300 shown in FIG. 3 includes an element 302 that displays motion data generated by the motion detection system. As shown in FIG. 3, the element 302 includes a horizontal timeline that includes a time period 304 (including a series of time points 306) and a plot of motion data indicating a degree of motion detected by the motion detection system for each time point in the series of time points 306. In the example shown, the user is notified that the detected motion started near a particular location (e.g., the kitchen) at a particular time (e.g., 9:04), and the relative degree of motion detected is indicated by the height of the curve at each time point.

The example user interface 300 shown in FIG. 3 also includes an element 308 that displays the relative degree of motion detected in each motion zone of the motion detection system. In particular, the element 308 indicates that 8% of the motion was detected in the “Entrance” zone while 62% of the motion was detected in the “Kitchen” zone. The data provided in the elements 302, 308 can help the user determine an appropriate action to take in response to the motion detection event, correlate the motion detection event with the user's observation or knowledge, determine whether the motion detection event was true or false, and so forth.

In some implementations, the output of the motion detection system may be provided in real-time (e.g., to an end user). Additionally, or alternatively, the output of the motion detection system may be stored (e.g., locally on the wireless communication devices 204, client devices 232, the APs 226, 228, or on a cloud-based storage service) and analyzed to reveal statistical information over a time frame (e.g., hours, days, or months). An example where the output of the motion detection system may be stored and analyzed to reveal statistical information over a time frame is in health monitoring, vital sign monitoring, sleep monitoring, etc. In some implementations, an alert (e.g., a notification, an audio alert, or a video alert) may be provided based on the output of the motion detection system. For example, a motion detection event may be communicated to another device or system (e.g., a security system or a control center), a designated caregiver, or a designated emergency contact based on the output of the motion detection system.

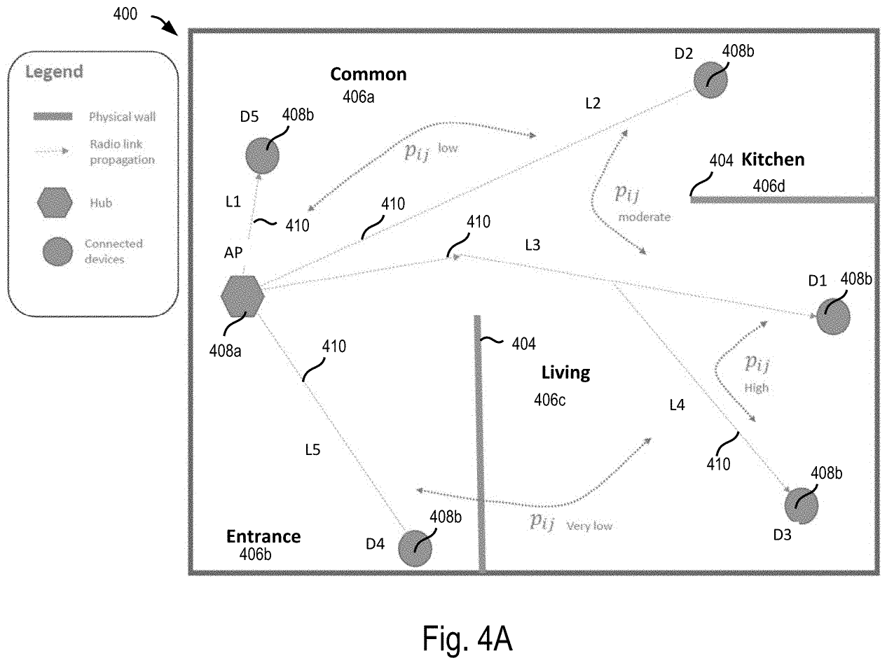

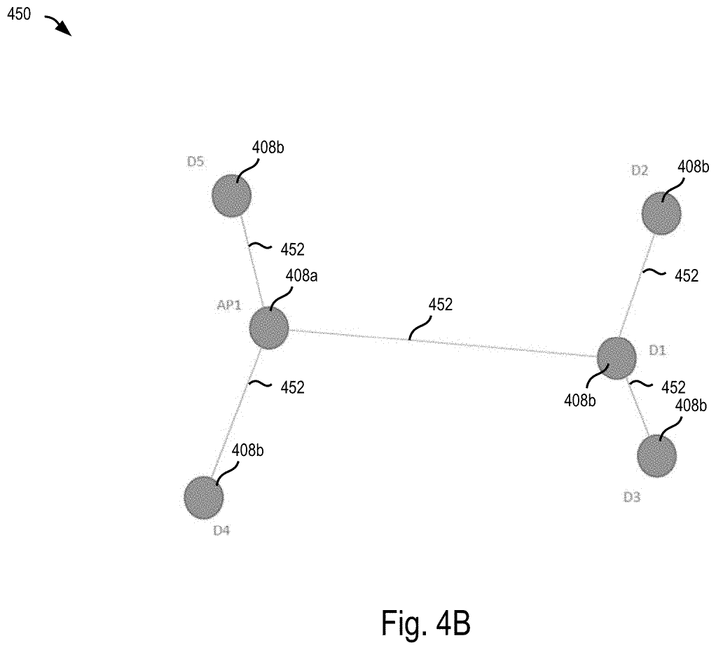

Now referring to FIG. 4A, a diagram is presented of an example space 400 associated with a wireless communication network 402. The example space 400 may be a residence partitioned by one or more physical walls 404 to define various regions 406 such as a common area 406a, an entrance 406b, a living room 406c, a kitchen 406d, and so forth. The wireless communication network 402 may include wireless communication devices 408 connected by wireless links 410. In FIG. 4A, the wireless communication devices 408 are labeled Di where i=the ith wireless communication device 408. Similarly, the wireless links 410 are labeled by Li where i=the ith wireless link 410. The wireless communication devices 408 may include a wireless AP 408a, which can serve as a hub in the wireless communication network 402, and a wireless client 408b, such as a mobile device, a smartphone, a smart watch, a tablet, a laptop computer, a smart thermostat, a wireless-enabled camera, a smart TV, a wireless-enabled speaker, a wireless-enabled power socket, and so forth. The wireless links 410 may be defined by respective pairs of wireless communication devices 408 in the wireless communication network 402. The wireless communication network 402 may be part or all of a motion detection system that, in many variations, generates motion-sensing data based on wireless signals transmitted over the wireless links 410.

In certain cases, the example space 400 may include an object or person that moves therein. The motion of such an object or person may disturb the wireless links 410, and in particular, pairs of wireless links 410 adjacent each other. A probability or likelihood—shown as pᵢⱼ in FIG. 4A—may be associated with pairs of wireless links that are sequentially disturbed by motion in time. Here, the values pᵢⱼ are referred to as probabilities because they are a set of normalized values; in some cases, likelihood values (which are not necessarily normalized) may be used in an equivalent manner. The probability or likelihood values may be generated based on motion-sensing data collected over a time period. For instance, the probability values pᵢⱼ may be computed from motion-sensing data representing disturbances detected on the wireless links 410 over a certain time period. In some examples, the probabilities or likelihoods are counted by observing link disturbances over several hours of motion detection system operation. The probability values pᵢⱼ may scale inversely in magnitude with a distance between wireless communication devices 408 defining the pair of wireless links. For example, the probability may scale inversely with a distance between a first wireless communication device associated with a first of the pair of wireless links and a second wireless communication device associated with a second of the pair of wireless links disturbed by the motion. The pair of wireless links may share a root wireless communication device in common (e.g., a wireless AP 408a). FIG. 4A depicts the pair of wireless links associated with respective wireless clients 408b. However, other types of wireless communication devices 408 are possible (e.g., APs).

The probability of sequential disturbance may be influenced by factors in the example space 400, such as a relative location of wireless communication devices 408 defining the pair of wireless links and physical objects (e.g., the one or more physical walls 404) therebetween. For example, wireless communication devices 408 that are close to each other, such as wireless communication devices D1 and D3, may define a pair of wireless links (e.g., L3 and L4) that have a higher probability of sequential disturbance than a pair of wireless links (e.g., L1 and L2) defined by wireless communications devices 408 that are farther away from each other, such as wireless communication devices D2 and D5. The presence of a physical wall 404 may impede motion of the object or person and thus reduce a transition of the object or person from one side of the physical wall 404 to the other. For example, the pair of wireless links L2 and L3 in the example space 400 are separated by a physical wall 404, and as such, the probability of their sequential disturbance may be reduced relative to situations where the physical wall 404 is absent.

In some implementations, the example space 400 corresponds to a house partitioned into different living spaces. The entrance 406b and the living room 406c may have a large wall separating them, so a person entering the entrance 406b will not be able to go into the living room 406c without passing through the common area 406a where the wireless AP 408a is located. Because the person is unable to traverse directly between the entrance 406b and the living room 406c, the motion-sensing data will only weakly represent transitions between the entrance and living room footprints of the wireless links 410 (e.g., between L4 and L5). As such, the motion-sensing data may provide a basis for a map of the house that places the entrance 406b and living room 406c away from each other. Moreover, the kitchen 406d is on a corner of the house opposite the entrance 406b. Motion between the entrance 406b to the kitchen 406d is even less likely than motion between the entrance 406b and the living room 406c. As such, the motion-sensing data will very weakly represent (if at all) transitions between the entrance and kitchen footprints of the wireless links 410 (e.g., between L2 and L5). In this case, the motion-sensing data may provide a basis for a map of the house that places the entrance 406b and kitchen 406d farther away from each other than the entrance 406b and living room 406c. However, the kitchen 406d and the living room 406c are separated by a partial wall. Such a configuration may be analogous to an “open concept” house and thus motion between the kitchen 406d and the living room 406c may be common. The motion-sensing data will therefore more strongly represent transitions between the kitchen and living room footprints of the wireless links 410 (e.g., L2 and L3). The motion-sensing data may therefore provide a basis for a map of the house that places the kitchen 406d and the living room 406c close to each other (e.g., adjacent each other).

As shown in FIG. 4A, different living spaces of the house may be associated with one or more wireless communication devices. The common area 406a, the entrance 406b, and the kitchen 406d are associated with, for example, respective wireless communication devices D5, D4, and D2. The living room 406c is associated with two wireless communication devices D1 and D3. In some instances, the one or more wireless communication devices allow the sequential disturbance of two wireless links 410 to be related to motion of an object or person between different living spaces. For example, the sequential disturbance of wireless links L2 and L3 may be related to motion between the living room 406c and the kitchen 406d. In some instances, the one or more wireless communication devices allow the sequential disturbance of two wireless links 410 to be related to motion within a single living space. For example, the sequential disturbance of wireless links L3 and L4 may be related to motion within the living room 406c.

As discussed above, the probability of disturbing a pair of wireless links 410 in the house can be related to a distance between two wireless communication devices associated with the pair of wireless links 410. For example, wireless communication devices D1 and D3 are closer to each other than wireless communication devices D2 and D5. As such, the probability of wireless links L3 and L4 being sequentially disturbed is higher than the probability of wireless links L1 and L2 being sequentially disturbed. Motion-sensing data for the house may therefore indicate a high frequency of disturbance for wireless links L3 and L4 relative to wireless links L1 and L2. This motion-sensing data may thus be used to determine the probabilities for the sequential disturbance of wireless links L3 and L4 relative to wireless links L1 and L2. The probabilities, in turn, allow for the distance between wireless communication devices D1 and D3 and the distance between wireless communication devices D2 and D5 to be determined. In general, motion-sensing data for pairs of wireless links 410 in the house may be used to determine distances between pairs of wireless communication devices 408, which in turn, can be used to determine a spatial map for the wireless communication devices 408.

FIG. 4B is a diagram of an example spatial map 450 based on the example space 400 of FIG. 4A. The example spatial map 450 represents a spatial arrangement of the wireless communication devices 408 in the example space 400. The spatial arrangement may be based on spatial coordinates (e.g., x-y coordinates) for each of the wireless communication devices 408 in a coordinate system of the example spatial map 450, and the spatial coordinates may be generated based on the motion-sensing data. In some instances, the coordinate system is a physical coordinate system (e.g., using physical coordinates). In other instances, the coordinate system is a logical coordinate system (e.g., using arbitrary coordinates). To generate the spatial coordinates, a computing device may process the motion-sensing data to determine distances between pairs of wireless communication devices 408, and from the distances, calculate the spatial coordinates. In many implementations, the spatial arrangement of the wireless communication devices 408 includes spatial paths 452 between select pairs of wireless communication devices 408. The computing device may determine the spatial paths 452 by generating a spanning tree from the spatial coordinates. For example, the computing device may execute a spanning tree algorithm to determine a minimum number of spatial paths 452 to connect the wireless communication devices 408. Accordingly, the spanning tree includes at least one spatial path connected to each of the wireless communication devices. In some instances, the minimum number corresponds to a number of spatial paths 452 with respective lengths that, when summed, have a minimum length. The spatial paths 452 represent estimated motion pathways between the wireless communication devices. As such, the spatial paths 452 are distinct from the wireless links 410 between the wireless communication devices. For instance, the wireless links 410 (which are traversed by wireless signals) can pass through the walls and physical barriers in the space, whereas the spatial paths 452 (which are traversed by people or other moving objects) typically would avoid the walls and other physical barriers.

In some implementations, the computing device determines the spatial coordinates by generating a final set of spatial coordinates from an initial set of spatial coordinates. For example, the computing device may execute program instructions that define an optimization process for the initial set of spatial coordinates. In these implementations, the computing device may produce a first data structure (e.g., a first matrix) from the motion-sensing data that includes a probability value for each pair of wireless links 410. The probability value may represent a probability of the pair of wireless links 410 being sequentially disturbed. The computing device also produces a second data structure (e.g., a second matrix) that includes a distance value for each pair of wireless communication devices 408 defining a wireless link 410. The distance value may be based on a probability value (e.g., a reciprocal thereof) and represents a distance between the pair of wireless communication devices 408. For instance, the distance dᵢⱼ between two devices may be related to the probability pᵢⱼ associated with the two devices as dᵢⱼ∝1/pᵢⱼ or otherwise. The computing device then converts the distance values into the initial set of spatial coordinates. The initial set of spatial coordinates indicates the locations of the wireless communication devices 408 in a two-dimensional coordinate system (e.g., an x-y coordinate system). The two-dimensional coordinate system may be a physical or logical coordinate system. In some instances, the computing device produces a third data structure (e.g., a third matrix) that includes the initial set of spatial coordinates.

In implementations using the optimization process, the computing device then selects arbitrary coordinates for a pair of wireless communication devices 408 that define a wireless link 410. The computing device subsequently determines, based on the arbitrary coordinates, a test distance between the pair of wireless communication devices 408. This test distance is subtracted from a distance value for the pair of wireless communication devices 408 in the second data structure. The resulting difference is then squared. For example, and with reference to FIG. 4A, the second data structure may have a distance value, dₚ¹², representing a distance between wireless communication devices D1 and D2. The distance value, dₚ¹², is based on a probability, p₂₃, of wireless links L2 and L3 being sequentially disturbed. The computing device selects arbitrary coordinates, represented by vector x, for wireless communication devices D1 and D2 in the two-dimensional coordinate system. Based on these coordinates, the computing device determines a test distance, dₓ¹², for wireless communication devices D1 and D2 and subtracts the distance value, dₚ¹², from the test distance. The difference is subsequently squared, e.g., (dₓ¹²−dₚ¹²)².

As part of the optimization process, the computing device determines a squared difference for each pair of wireless communication devices 408 defining a wireless link 410 (e.g., as described above). The computing device then sums all of the squared differences to produce a residual value that characterizes the arbitrary coordinates selected for the pairs of wireless communication devices 408. The computing device subsequently alters the arbitrary coordinates in iterative fashion to find a minimum residual value. The arbitrary coordinates associated with the minimum residual value correspond to the final set of spatial coordinates and may be aggregated into a third data structure (e.g., a third matrix). In some cases, the optimization process can use the objective:

$$X = arg {min}_{x} \sum {( D ( X ) - {D}_{p} )}^{2}$$

where X is a vector of coordinates for each device; D(X) is a distance matrix generator from coordinates, and Dₚ is a distance matrix generator from inverse probabilities.

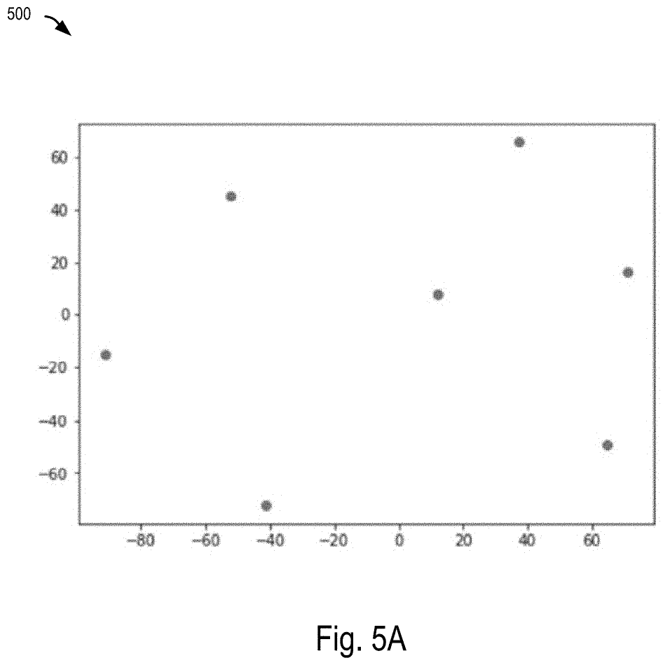

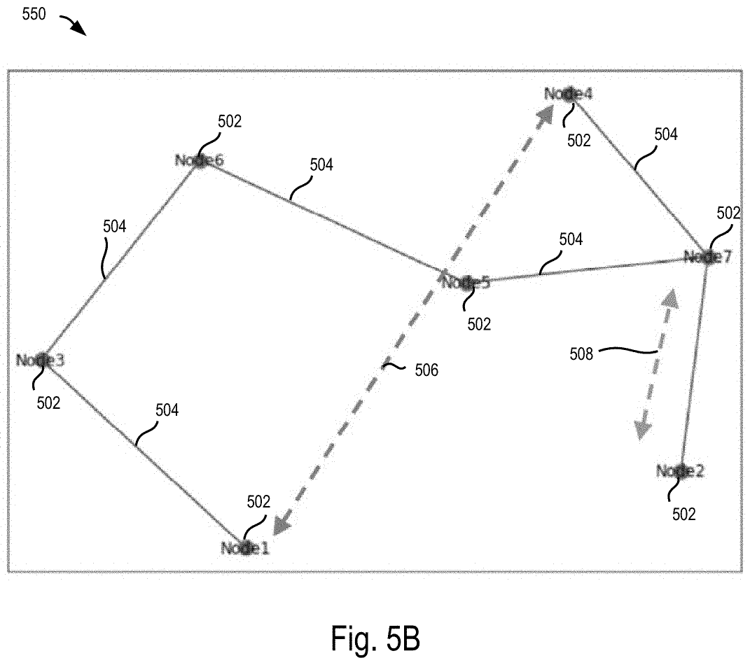

FIG. 5A is a graph 500 showing example spatial coordinates for respective wireless communication devices in a wireless communication network. The wireless communication devices may be analogous to those described in relation to FIGS. 4A-4B. The graph 500 includes a two-dimensional coordinate system for the example spatial coordinates. The two-dimensional coordinate system may be based on physical units defining dimensional aspects of a physical space, or alternatively, logical units representing the dimensional aspects. In many variations, the logical units are derived from motion-sensing data that characterizes motion (or an absence thereof) in a space occupied by the wireless communication devices. FIG. 5A illustrates seven spatial coordinates having the following pairs of coordinate values:

$$[ \begin{matrix}- 41.26 & - 72.33 \\ 64.41 & - 48.97 \\ - 91.05 & - 15.06 \\ 37.15 & 66.06 \\ 12.23 & 8.29 \\ - 52.45 & 45.59 \\ 70.97 & 16.43\end{matrix} ]$$

However, other numbers of spatial coordinates are possible and these spatial coordinates may have different, respective pairs of coordinate values than those shown above.

FIG. 5B is a graph 500 showing an example spanning tree for the example spatial coordinates of FIG. 5A. The example spanning tree may be determined using an optimization process, such as described above in relation to FIG. 4B. The example spanning tree includes spatial paths 502 connecting wireless communication devices 504 (or nodes). Moreover, the wireless communication devices 504 are associated with distances in the two-dimensional coordinate system as follows:

$$[ \begin{matrix}0.00 & 34.96 & 21.16 & 94.69 & 65.70 & 38.05 & 49.46 \\ 34.96 & 0.00 & 81.61 & 47.96 & 24.20 & 87.45 & 20.76 \\ 21.16 & 81.61 & 0.00 & 68.37 & 27.49 & 19.06 & 91.91 \\ 94.69 & 47.96 & 68.37 & 0.00 & 21.50 & 25.76 & 18.38 \\ 65.70 & 24.20 & 27.49 & 21.50 & 0.00 & 51.81 & 42.44 \\ 38.05 & 87.45 & 19.06 & 25.76 & 51.81 & 0.00 & 32.23 \\ 49.46 & 20.76 & 91.91 & 18.38 & 42.44 & 32.23 & 0.00\end{matrix} ]$$

In the matrix above, each element, Dᵢⱼ, represents a distance between a pair of wireless communication devices, i.e., the i-th and j-th wireless communication devices. The matrix is symmetric, indicating that a distance in a forward direction is the same as a distance in a reverse direction and that a distance between the same wireless communication device is null. For example, the distance from the 1^{st} to the 3^{rd} wireless communication device (i.e., D₁₃=21.16) is the same as the distance from the 3^{rd} to the 1^{st} wireless communication device (i.e., D₃₁=21.16). The distance between the 2^{nd} wireless communication devices is zero (i.e., D₂₂=0.00).

The example spanning tree may allow a user to perceive spatial relationships and connective distances between the wireless communication devices 504. For example, the graph 500 includes a dotted line 506 to indicate the pair of wireless communication devices having the longest distance therebetween. The pair of wireless communication devices corresponds to nodes 1 and 4. Consistent with this indication, the largest value of the matrix (i.e., 94.69) is associated with elements D₁₄ and D₄₁. As another example, the graph 500 includes a dotted line 508 to indicate a pair of wireless communication devices having a short distance therebetween. Consistent with this indication, a smaller value of the matrix (i.e., 20.67) is associated with elements D₂₇ and D₇₂. The smaller value is close to the smallest value of the matrix (19.06).

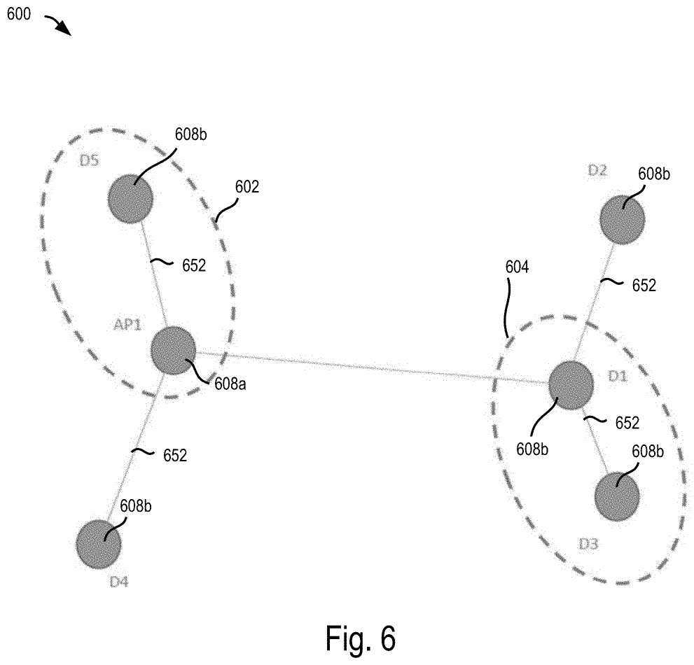

Now referring to FIG. 6, a diagram is presented of an example spatial map 600 indicating groups 602, 604 of wireless communication devices selected according to a common characteristic. The example spatial map 600 may be analogous to the example spatial map 450 described in relation to FIG. 4B, and features analogous to both FIGS. 4B and 6 are related via coordinated numerals that differ in increment by two hundred. The example spatial map 600 may be displayed on a display device—such as part of a graphical user interface—to receive user input regarding wireless communication devices that share common characteristics. For example, a user may input information into the display device selecting a first group of wireless communication devices 602 to be associated with a first region of a space (e.g., the common area 406a of FIG. 4A) and a second group of wireless communication devices 604 to be associated with a second region of the space (e.g., living room 406c of FIG. 4A). The display device may communicate the user input to a motion detection system, which in turn, may assign first and second motion zones to, respectively, the first and second groups of wireless communication devices 602, 604.

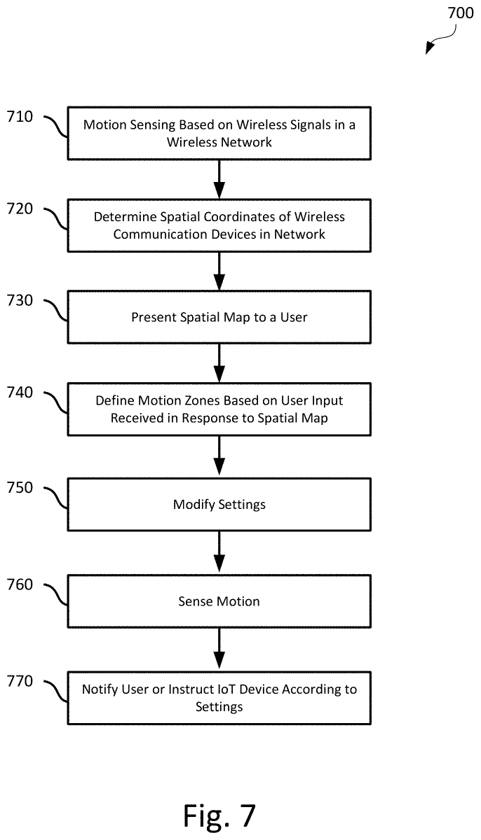

FIG. 7 is a flow chart showing an example process 700 performed, for example, by a motion detection system. The motion detection system can process information based on wireless signals transmitted (e.g., on wireless links between wireless communication devices) through a space to detect motion of objects in the space (e.g., as described with respect to FIGS. 1 and 2A, 2B, 2C, or otherwise). Operations of the example process 700 may be performed by a remote computer system (e.g., a server in the cloud), a wireless communication device (e.g., one or more of the wireless communication devices), or another type of system. For example, one or more of the operations in the example process 700 may be performed by one or more of the example wireless communication devices 102A, 102B, 102C in FIG. 1, client devices 232 or the APs 226, 228 in FIG. 2C, the wireless communication devices 408 of FIGS. 4A-4B, or by a cloud-based computer system.

The example process 700 may include additional or different operations, and the operations may be performed in the order shown or in another order. In some cases, one or more of the operations shown in FIG. 7 can be implemented as processes that include multiple operations, sub-processes, or other types of routines. In some cases, operations can be combined, performed in another order, performed in parallel, iterated or otherwise repeated, or performed in another manner.

At 710, motion is sensed based on wireless signals communicated in a wireless network. For example, motion-sensing data may be generated based on first wireless signals transmitted, during a first time period, over wireless links defined by respective pairs of wireless communication devices in a wireless communication network. The motion-sensing data may represent changes to a channel or disturbances of the wireless links caused by motion in a space associated with the wireless communication network.

At 720, spatial coordinates of wireless communication devices in the wireless network are determined. For example, spatial coordinates for the respective wireless communication devices may be generated based on the motion-sensing data. The spatial coordinates for each wireless communication device may represent a location of the wireless communication device in the space.

At 730, a spatial map is presented to a user, such as through a graphical interface on a display device. For example, user input may be received in response to a graphical representation of a spatial arrangement (or spatial map) of the wireless communication devices being displayed on a display device. The graphical representation of the spatial arrangement shows the user how the wireless communication devices are physically situated relative to one another in the space, and may provide information about how different regions or zones within the space are connected to one another. The spatial arrangement may include two-dimensional spatial information (e.g., a floor plan view), three-dimensional spatial information (e.g., a combination of plan, elevation or perspective views), or other spatial information. The spatial arrangement may be generated based on the spatial coordinates, and the user input may indicate a selected group of the wireless communication devices that share a common characteristic.

At 740, one or more motion zones are defined based on user input received in response to presenting the spatial map. For example, motion zones may be defined in a motion detection system associated with the space. Each of the motion zones may represent a distinct region in the space; for example, the motion zones may represent distinct rooms, segments, quadrants, levels, or a combination of these and other types of regions. The motion zones may include a first motion zone representing a first region that includes the selected group of the wireless communication devices. The motion zones may include additional motion zones that each include one or more of the other wireless communication devices.

At 750, settings in the motion detection system are modified. For example, user input received at 730 may include names or labels for the motion zones, and the motion detection system settings may be modified at 750 to associate the new names or labels with the respective motion zones. As another example, the motion detection system settings may be modified to designate actions to be executed when motion is detected by the system. For instance, the motion detection system may be programmed to send an instruction, command, or notification to a particular device when motion is detected in one or more of the motion zones.

At 760, motion is sensed by the motion detection system, such as motion in the one or more motion zones. For example, the motion detection system may detect motion of an object in the space based on second wireless signals transmitted over one or more of the wireless links during a second time period.

At 770, a user device may be notified, or an internet-of-things (IoT) device may be instructed according to the settings (or modified settings). For example, in response to identifying one of the wireless communication devices in the selected group of the wireless communication devices as a location of the motion, a message indicating that motion was detected in the first motion zone may be generated. After generating the message, the message can be sent to a device associated with the motion detection system, such as an IoT device or the user device. In some cases, when the message is sent to the user device, the user device generates a graphical display (such as the example shown in FIG. 3) that informs the user of the motion (e.g., when and where the motion was detected). As another example, in response to identifying one of the wireless communication devices in the selected group of the wireless communication devices as a location of the motion, instructions may be sent to a device associated with the motion detection system to alter a state of the device. In some instances, the state may be a power state, such as an on-off state.

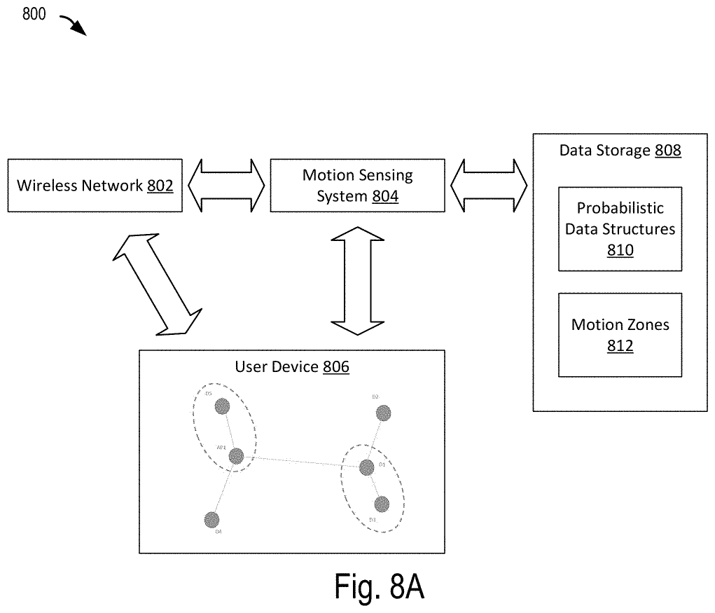

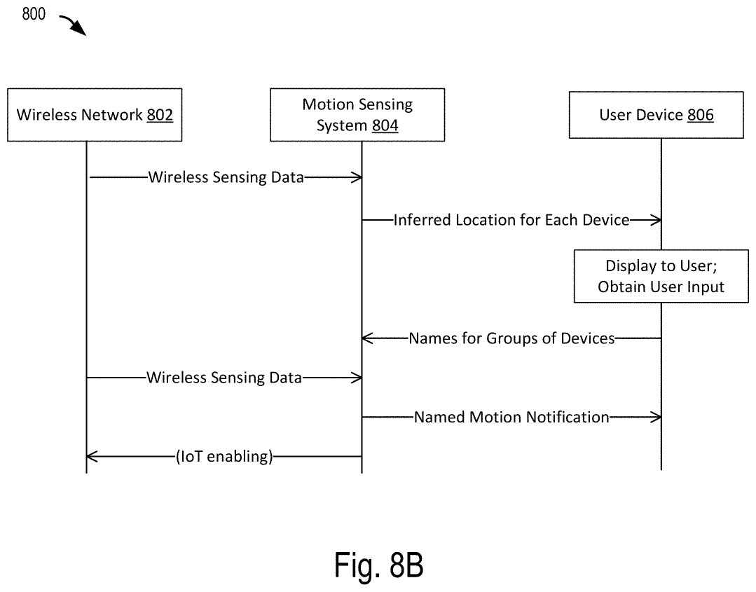

FIG. 8A is a block diagram schematically representing an example system 800 that includes a user device 806 and a wireless network 802 interacting with a motion sensing system 804. The wireless network 802 can be, for example, any of the types of wireless communication networks described with respect to FIGS. 1 and 2C, or another type of wireless network. The user device 806 can be, for example, a smartphone, a laptop computer, a tablet, a smart watch, a smart television, or another type of device that includes a display and receives feedback or other input from a user. The motion sensing system 804 can be a computer-implemented system (e.g., software, hardware, firmware, or combinations thereof) that senses motion based on signals exchanged in the wireless network 802, for example, as described with respect to FIGS. 1, 2A, 2B, 2C, or otherwise. The system 800 also includes data storage 808, which stores probabilistic data structures 810 and motion zones 812. The data storage 808 can include any form of data storage on a local device (local to the wireless network 802), a remote device, a cloud-based system, or another type of data storage. The system 800 may include additional or different features, and the features of the system 800 may be configured in another manner.

FIG. 8B is a signaling and flow diagram representing example operations that may be performed in the system 800 shown in FIG. 8A. As shown in FIG. 8B, the wireless network 802 sends wireless sensing data to the motion sensing system 804. The motion sensing system 803 can then infer a location for devices in the wireless network 802 based on the motion sensing data (e.g., as described above with respect to FIGS. 4A, 4B, 5A, 5B, or otherwise). The inferred location information is then sent to the user device 806, which displays a graphical representation of the spatial arrangement of the devices to the user. The user device 806 then obtains user input in response to the graphical representation. The user input may be obtained, for example, as a result of a user interaction with a touch screen, a stylus, a keyboard, a pointing device, or another type of user interface. The user input includes a selection of devices that share a common characteristic (e.g., as described with respect to FIG. 6). For instance, the user may select a group of devices that are all in the same room, and the user may also provide a name for the room (e.g., “living room”). The user device 806 then sends information to the motion sensing system 804 based on the user input, and the motion sensing system 804 defines (or updates) motion zones based on the information from the user device 806. For example, the motion sensing system 804 may update the probabilistic data structures 810, the motion zones 812, or other information stored on the data storage 808. Later, the wireless network 802 sends wireless sensing data to the motion sensing system 804, which detects motion of an object based on the wireless sensing data. The motion sensing system 804 may then send a message to the user device 806, to the wireless network 802, to another system or device, or to multiple systems or devices. For example, the message may notify the user device 806 that motion was detected in a motion zone, and the notification may include the name (e.g., “living room”) that was provided by the user. As another example, the message may include an instruction or command for a smart device in the wireless network 802. For instance, the instruction may modify a light setting, a temperature setting, activate or deactivate a device, or perform another action.

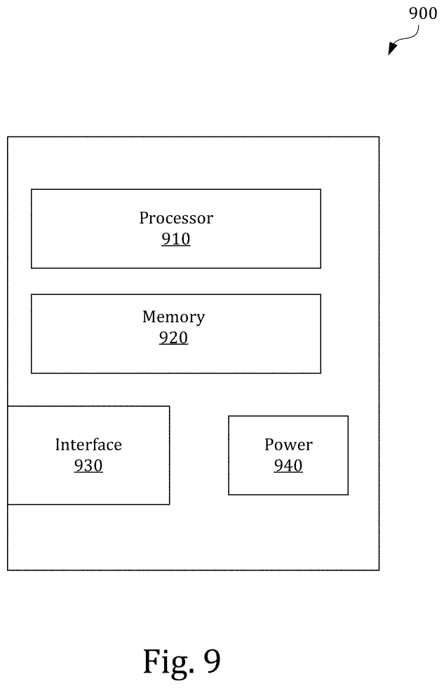

FIG. 9 is a block diagram showing an example wireless communication device 900. As shown in FIG. 9, the example wireless communication device 900 includes an interface 930, a processor 910, a memory 920, and a power unit 940. A wireless communication device (e.g., any of the wireless communication devices 102A, 102B, 102C in FIG. 1) may include additional or different components, and the wireless communication device 900 may be configured to operate as described with respect to the examples above. In some implementations, the interface 930, processor 910, memory 920, and power unit 940 of a wireless communication device are housed together in a common housing or other assembly. In some implementations, one or more of the components of a wireless communication device can be housed separately, for example, in a separate housing or other assembly.

The example interface 930 can communicate (receive, transmit, or both) wireless signals. For example, the interface 930 may be configured to communicate radio frequency (RF) signals formatted according to a wireless communication standard (e.g., Wi-Fi, 4G, 5G, Bluetooth, etc.). In some implementations, the example interface 930 includes a radio subsystem and a baseband subsystem. The radio subsystem may include, for example, one or more antennas and radio frequency circuitry. The radio subsystem can be configured to communicate radio frequency wireless signals on the wireless communication channels. As an example, the radio subsystem may include a radio chip, an RF front end, and one or more antennas. The baseband subsystem may include, for example, digital electronics configured to process digital baseband data. In some cases, the baseband subsystem may include a digital signal processor (DSP) device or another type of processor device. In some cases, the baseband system includes digital processing logic to operate the radio subsystem, to communicate wireless network traffic through the radio subsystem or to perform other types of processes.

The example processor 910 can execute instructions, for example, to generate output data based on data inputs. The instructions can include programs, codes, scripts, modules, or other types of data stored in memory 920. Additionally or alternatively, the instructions can be encoded as pre-programmed or re-programmable logic circuits, logic gates, or other types of hardware or firmware components or modules. The processor 910 may be, or include, a general-purpose microprocessor, as a specialized co-processor, or another type of data processing apparatus. In some cases, the processor 910 performs high level operation of the wireless communication device 900. For example, the processor 910 may be configured to execute or interpret software, scripts, programs, functions, executables, or other instructions stored in the memory 920. In some implementations, the processor 910 may be included in the interface 930 or another component of the wireless communication device 900.

The example memory 920 may include computer-readable storage media, for example, a volatile memory device, a non-volatile memory device, or both. The memory 920 may include one or more read-only memory devices, random-access memory devices, buffer memory devices, or a combination of these and other types of memory devices. In some instances, one or more components of the memory can be integrated or otherwise associated with another component of the wireless communication device 900. The memory 920 may store instructions that are executable by the processor 910. For example, the instructions may include instructions to perform one or more of the operations in the example process 700 shown in FIG. 7.

The example power unit 940 provides power to the other components of the wireless communication device 900. For example, the other components may operate based on electrical power provided by the power unit 940 through a voltage bus or other connection. In some implementations, the power unit 940 includes a battery or a battery system, for example, a rechargeable battery. In some implementations, the power unit 940 includes an adapter (e.g., an AC adapter) that receives an external power signal (from an external source) and converts the external power signal to an internal power signal conditioned for a component of the wireless communication device 900. The power unit 920 may include other components or operate in another manner.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to, and receiving documents from, a device that is used by the user; for example, by sending web pages to a web browser on a user's client device in response to requests received from the web browser.

In a general aspect, the systems and techniques described here allow for determining spatial maps based on user input and motion-sensing data derived from wireless signals.

In a first example, a method includes generating motion-sensing data based on first wireless signals transmitted, during a first time period, over wireless links defined by respective pairs of wireless communication devices in a wireless communication network. The motion-sensing data represents disturbances of the wireless links caused by motion in a space associated with the wireless communication network. The method also includes generating spatial coordinates for the respective wireless communication devices based on the motion-sensing data. The spatial coordinates for each wireless communication device represent a location of the wireless communication device in the space. The method additionally includes receiving user input in response to a graphical representation of a spatial arrangement of the wireless communication devices being displayed on a display device. The spatial arrangement is generated based on the spatial coordinates, and the user input indicates a selected group of the wireless communication devices that share a common characteristic.

The method also includes defining a plurality of motion zones in a motion detection system associated with the space. Each of the plurality of motion zones represents a distinct region in the space, and the plurality of motion zones comprises a first motion zone representing a space that includes the selected group of the wireless communication devices. Moreover, the method includes detecting, by operation of the motion detection system, motion of an object in the space based on second wireless signals transmitted over one or more of the wireless links during a second time period. The method further includes generating, in response to identifying one of the wireless communication devices in the selected group of the wireless communication devices as a location of the motion, a message indicating that motion was detected in the first motion zone. The method still further includes sending the message to a device associated with the motion detection system.

Implementations of the first example may include one or more of the following features. For example, the method may include identifying, based on the spatial coordinates, spatial paths between the wireless communication devices. In this example, the graphical representation of the spatial arrangement indicates the spatial paths. In some instances, the spatial paths are identified by generating a spanning tree from the spatial coordinates.

Implementations of the first example may also include one or more of the following features. For example, the user input may indicate a name associated with the selected group of the wireless communication devices. In this example, defining the first motion zone includes associating the name with the first motion zone. Moreover, the message indicates the name associated with the first motion zone. Also in this example, sending the message to the device associated with the motion detection system includes sending the notification to the user device. In some instances, the user input indicates that the selected group of the wireless communication devices are associated with the same room in the space, and the name indicated by the user input is a name of the room.

Implementations of the first example may additionally include one or more of the following features. For example, sending the message to the device associated with the motion detection system may include instructing the device associated with the motion detection system to perform an operation in response to motion being detected in the first motion zone.

Implementations of the first example may further include one or more of the following features. For example, generating the spatial coordinates may include generating, based on the first motion-sensing data, likelihood values for pairs of the wireless communication devices. The likelihood value for each pair of wireless communication devices represents a likelihood of sensing motion at the pair of wireless communication devices sequentially in time. In this example, generating the spatial coordinates also includes generating, based on the likelihood values, distance values for the respective pairs of wireless communication devices. The distance value for each pair of wireless communication devices represents a distance between two of the wireless communication devices. Also in this example, generating the spatial coordinates includes generating the spatial coordinates based on the distance values. In some instances, the distance values are generated by an optimization process.

Implementations of the first example may still further include one or more of the following features. For example, generating spatial coordinates for the respective wireless communication devices may include generating spatial coordinates for each MAC address in the wireless communication network.

Implementations of the first example may yet further include one or more of the following features. For example, the spatial coordinates may be generated for a two-dimensional coordinate system, and the graphical representation of the spatial arrangement may include a two-dimensional map of the wireless communication devices.

In a second example, a non-transitory computer-readable medium stores instructions that are operable when executed by data processing apparatus to perform one or more operations of the first example. In a third example, a system includes a plurality of wireless communication devices, and a computer device configured to perform one or more operations of the first example.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method comprising:
generating motion-sensing data based on first wireless signals transmitted, during a first time period, between pairs of wireless communication devices in a wireless communication network, the motion-sensing data representing motion in a space associated with the wireless communication network;
based on the motion-sensing data, generating spatial coordinates for the respective wireless communication devices, the spatial coordinates for each wireless communication device representing a location of the wireless communication device in the space;
receiving user input in response to a graphical representation of a spatial arrangement of the wireless communication devices being displayed on a display device, the spatial arrangement being generated based on the spatial coordinates, the user input indicating a selected group of the wireless communication devices that share a common characteristic; and
defining a plurality of motion zones in a motion detection system associated with the space, each of the plurality of motion zones representing a distinct region in the space, the plurality of motion zones comprising a first motion zone representing a first region that includes the selected group of the wireless communication devices.

2. The method of claim 1, comprising:
based on the spatial coordinates, identifying spatial paths between the wireless communication devices, the graphical representation of the spatial arrangement indicating the spatial paths.

3. The method of claim 2, wherein the spatial paths are identified by generating a spanning tree from the spatial coordinates.

4. The method of claim 1, further comprising:
by operation of the motion detection system, detecting motion of an object in the space based on second wireless signals transmitted between one or more pairs of the wireless communication devices during a second time period;
in response to identifying one of the wireless communication devices in the selected group of the wireless communication devices as a location of the detected motion of the object, generating a message indicating that motion was detected in the first motion zone; and
sending the message to a device associated with the motion detection system.

5. The method of claim 4,
wherein the user input indicates a name associated with the selected group of the wireless communication devices;
wherein defining the first motion zone comprises associating the name with the first motion zone;
wherein the message indicates the name associated with the first motion zone; and
wherein sending the message to the device associated with the motion detection system comprises sending the notification to the user device.

6. The method of claim 5, wherein the user input indicates that the selected group of the wireless communication devices are associated with the same room in the space, and the name indicated by the user input is a name of the room.

7. The method of claim 4, wherein sending the message to the device associated with the motion detection system comprises instructing the device associated with the motion detection system to perform an operation in response to motion being detected in the first motion zone.

8. The method of claim 1, wherein generating the spatial coordinates comprises:
generating, based on the first motion-sensing data, likelihood values for pairs of the wireless communication devices, the likelihood value for each pair of wireless communication devices representing a likelihood of sensing motion at the pair of wireless communication devices sequentially in time;
generating, based on the likelihood values, distance values for the respective pairs of wireless communication devices, the distance value for each pair of wireless communication devices representing a distance between two of the wireless communication devices; and
generating the spatial coordinates based on the distance values.

9. The method of claim 8, wherein the distance values are generated by an optimization process.

10. The method of claim 1, wherein generating spatial coordinates for the respective wireless communication devices comprises generating spatial coordinates for each MAC address in the wireless communication network.

11. The method of claim 1, wherein the spatial coordinates are generated for a two-dimensional coordinate system, and the graphical representation of the spatial arrangement comprises a two-dimensional map of the wireless communication devices.

12. A non-transitory computer-readable medium comprising instructions that are operable, when executed by data processing apparatus, to perform operations comprising:
generating motion-sensing data based on first wireless signals transmitted, during a first time period, between pairs of wireless communication devices in a wireless communication network, the motion-sensing data representing motion in a space associated with the wireless communication network;
based on the motion-sensing data, generating spatial coordinates for the respective wireless communication devices, the spatial coordinates for each wireless communication device representing a location of the wireless communication device in the space;
receiving user input in response to a graphical representation of a spatial arrangement of the wireless communication devices being displayed on a display device, the spatial arrangement being generated based on the spatial coordinates, the user input indicating a selected group of the wireless communication devices that share a common characteristic; and
defining a plurality of motion zones in a motion detection system associated with the space, each of the plurality of motion zones representing a distinct region in the space, the plurality of motion zones comprising a first motion zone representing a first region that includes the selected group of the wireless communication devices.

13. The computer-readable medium of claim 12, comprising:
based on the spatial coordinates, identifying spatial paths between the wireless communication devices, the graphical representation of the spatial arrangement indicating the spatial paths.

14. The computer-readable medium of claim 13, wherein the spatial paths are identified by generating a spanning tree from the spatial coordinates.

15. The computer-readable medium of claim 12, the operations further comprising:
detecting motion of an object in the space based on second wireless signals transmitted between one or more pairs of the wireless communication devices during a second time period;
in response to identifying one of the wireless communication devices in the selected group of the wireless communication devices as a location of the detected motion of the object, generating a message indicating that motion was detected in the first motion zone; and
sending the message to a device associated with the motion detection system.

16. The computer-readable medium of claim 15,
wherein the user input indicates a name associated with the selected group of the wireless communication devices;
wherein defining the first motion zone comprises associating the name with the first motion zone;
wherein the message indicates the name associated with the first motion zone; and
wherein sending the message to the device associated with the motion detection system comprises sending the notification to the user device.

17. The computer-readable medium of claim 16, wherein the user input indicates that the selected group of the wireless communication devices are associated with the same room in the space, and the name indicated by the user input is a name of the room.

18. The computer-readable medium of claim 15, wherein sending the message to the device associated with the motion detection system comprises instructing the device associated with the motion detection system to perform an operation in response to motion being detected in the first motion zone.

19. The computer-readable medium of claim 12, wherein generating the spatial coordinates comprises:
generating, based on the first motion-sensing data, likelihood values for pairs of the wireless communication devices, the likelihood value for each pair of wireless communication devices representing a likelihood of sensing motion at the pair of wireless communication devices sequentially in time;
generating, based on the likelihood values, distance values for the respective pairs of wireless communication devices, the distance value for each pair of wireless communication devices representing a distance between two of the wireless communication devices; and
generating the spatial coordinates based on the distance values.

20. The computer-readable medium of claim 12, wherein generating spatial coordinates for the respective wireless communication devices comprises generating spatial coordinates for each MAC address in the wireless communication network.

21. The computer-readable medium of claim 12, wherein the spatial coordinates are generated for a two-dimensional coordinate system, and the graphical representation of the spatial arrangement comprises a two-dimensional map of the wireless communication devices.

22. A system comprising:
a plurality of wireless communication devices in a wireless communication network; and
a computer device comprising one or more processors operable to perform operations comprising:
generating motion-sensing data based on first wireless signals transmitted, during a first time period, between pairs of wireless communication devices in a wireless communication network, the motion-sensing data representing motion in a space associated with the wireless communication network;
based on the motion-sensing data, generating spatial coordinates for the respective wireless communication devices, the spatial coordinates for each wireless communication device representing a location of the wireless communication device in the space;
receiving user input in response to a graphical representation of a spatial arrangement of the wireless communication devices being displayed on a display device, the spatial arrangement being generated based on the spatial coordinates, the user input indicating a selected group of the wireless communication devices that share a common characteristic; and
defining a plurality of motion zones in a motion detection system associated with the space, each of the plurality of motion zones representing a distinct region in the space, the plurality of motion zones comprising a first motion zone representing a first region that includes the selected group of the wireless communication devices.

23. The system of claim 22, the operations comprising:
based on the spatial coordinates, identifying spatial paths between the wireless communication devices, the graphical representation of the spatial arrangement indicating the spatial paths.

24. The method of claim 23, wherein the spatial paths are identified by generating a spanning tree from the spatial coordinates.

25. The system of claim 22, the operations further comprising:
detecting motion of an object in the space based on second wireless signals transmitted between one or more pairs of the wireless communication devices during a second time period;
in response to identifying one of the wireless communication devices in the selected group of the wireless communication devices as a location of the detected motion of the object, generating a message indicating that motion was detected in the first motion zone; and
sending the message to a device associated with the motion detection system.

26. The system of claim 25,
wherein the user input indicates a name associated with the selected group of the wireless communication devices;
wherein defining the first motion zone comprises associating the name with the first motion zone;
wherein the message indicates the name associated with the first motion zone; and
wherein sending the message to the device associated with the motion detection system comprises sending the notification to the user device.

27. The system of claim 26, wherein the user input indicates that the selected group of the wireless communication devices are associated with the same room in the space, and the name indicated by the user input is a name of the room.

28. The system of claim 25, wherein sending the message to the device associated with the motion detection system comprises instructing the device associated with the motion detection system to perform an operation in response to motion being detected in the first motion zone.

29. The system of claim 22, wherein generating the spatial coordinates comprises:
generating, based on the first motion-sensing data, likelihood values for pairs of the wireless communication devices, the likelihood value for each pair of wireless communication devices representing a likelihood of sensing motion at the pair of wireless communication devices sequentially in time;
generating, based on the likelihood values, distance values for the respective pairs of wireless communication devices, the distance value for each pair of wireless communication devices representing a distance between two of the wireless communication devices; and
generating the spatial coordinates based on the distance values.

30. The system of claim 22, wherein generating spatial coordinates for the respective wireless communication devices comprises generating spatial coordinates for each MAC address in the wireless communication network.
